(19) United States
(12) Patent Application Publication
(10) Pub. No.: US 2015/0066412 A1
(43) Pub. Date: Mar. 5, 2015

(54) METHOD AND DEVICE FOR CALIBRATING A SURROUNDINGS SENSOR

(71) Applicant: Stefan Nordbruch, Kornwestheim (DE)

(72) Inventor: Stefan Nordbruch, Kornwestheim (DE)

(21) Appl. No.: 14/350,475

(22) PCT Filed: Aug. 24, 2012
(86) PCT No.: PCT/EP2012/066518

§ 371 Date: Aug. 11, 2014

(30) Foreign Application Priority Data
Oct. 11, 2011 (DE) 10 2011 084 264.0

(51) Int. Cl. G01D 18/00; B60W 40/00

(52) U.S. Cl. CPC G01D 18/002; B60W 40/00
USPC 702/104

(57) ABSTRACT

In a method for calibrating a surroundings sensor for sensory detection of the surroundings of a vehicle, sensor data which are generated with the aid of the surroundings sensor and which correspond to the vehicle surroundings are transmitted to a server situated externally from the vehicle, and the server transmits calibration data generated based on the sensor data and on reference sensor data which correspond to the reference vehicle surroundings associated with the vehicle surroundings to the surroundings sensor. In the case of an unsuccessful sensor calibration, an error signal is transmitted to a control unit which subsequently controls a vehicle component.

### BACKGROUND OF THE INVENTION

1. Field of the Invention

The present invention relates to a method and a device for calibrating a surroundings sensor for sensory detection of the surroundings of a vehicle, as well as a computer program.

2. Description of the Related Art

A calibration method for a sensor of a sensor system of a vehicle is known from patent application published European patent application document EP 0 921 509. Here, the sensor sensorially detects the vehicle surroundings and transmits corresponding sensor data to a server. The server compares the sensor data to reference sensor data and transmits a corresponding result back to the sensor. The sensor may then be calibrated based on this result.

### BRIEF SUMMARY OF THE INVENTION

The object of the present invention may thus be seen as providing an improved method and an improved device for calibrating a surroundings sensor for sensory detection of the surroundings of a vehicle.

The object of the present invention may also be seen as providing a corresponding system for calibrating a surroundings sensor for sensory detection of the surroundings of a vehicle.

The object of the present invention may also be seen as providing a corresponding computer program.

According to one aspect, a method is provided for calibrating a surroundings sensor for sensory detection of the surroundings of a vehicle. This means in particular that the surroundings sensor is designed for sensory detection of vehicle surroundings.

Here, sensor data which are generated with the aid of the surroundings sensor and correspond to the vehicle surroundings are transmitted to a server situated externally from the vehicle, so that the server may check the sensor data. The server forms calibration data for a sensor calibration based on the sensor data and the reference sensor data. The reference sensor data correspond in particular to the reference vehicle surroundings associated with the vehicle surroundings.

These calibration data are transmitted to the surroundings sensor, so that the sensor may be calibrated based on the calibration data.

In the case of an unsuccessful sensor calibration, an error signal is transmitted to a control unit which then controls a vehicle component.

According to another aspect, a device is provided for calibrating a surroundings sensor for sensory detection of the surroundings of a vehicle. A transmitter is provided which is configured to transmit sensor data which are generated with the aid of the surroundings sensor and which correspond to the vehicle surroundings to a server situated externally from the vehicle in order to check the sensor data.

Furthermore, a receiver is provided for receiving the calibration data generated with the aid of the server for a sensor calibration. The calibration data are based on the sensor data and on reference sensor data which correspond to the reference vehicle surroundings associated with the vehicle surroundings.

Furthermore, a control unit is provided for controlling a vehicle component. Furthermore, an error signal generator is provided for generating and transmitting an error signal to the control unit in the case of an unsuccessful calibration. In this case, the control unit is designed to control the vehicle component after the error signal has been received from the control unit.

According to yet another aspect, a system is provided for calibrating a surroundings sensor for sensory detection of the surroundings of a vehicle. The system includes the device for calibrating a surroundings sensor for sensory detection of the surroundings of a vehicle. Furthermore, the system includes a server having a database in which reference sensor data are stored. The reference sensor data correspond to the reference vehicle surroundings.

According to yet another aspect, a computer program is provided which includes program code for carrying out the method for calibrating a surroundings sensor for sensory detection of the surroundings of a vehicle, when the computer program is executed on a computer, in particular a control unit.

The present invention thus includes the idea of sensorially detecting the vehicle surroundings. The corresponding sensor data are then transmitted to an external server. The server compares the sensor data to reference sensor data and forms corresponding calibration data based on the comparison. These calibration data are then transmitted by the server back to the surroundings sensor, so that the sensor may be calibrated based on the calibration data. If a sensor calibration is not possible or if the carried-out sensor calibration was unsuccessful, an error signal is generated. This error signal is transmitted to a control unit which then controls a vehicle component.

According to the present invention, the case of an unsuccessful sensor calibration is contemplated, suitable measures being taken in the case of an unsuccessful sensor calibration. In this case, the case of an unsuccessful sensor calibration is not described in the related art. According to the present invention, an improved and expanded method, a corresponding device, a corresponding system, and a corresponding computer program are provided for calibrating a surroundings sensor, since other situations, in this case in particular the unsuccessful sensor calibration, may be detected and considered according to the present invention.

In the sense of the present invention, the term “externally” designates an area which is outside of the vehicle. The term “internally” designates in the sense of the present invention in particular an area situated within the vehicle.

Sensor data in the sense of the present invention include, in particular, information regarding the vehicle surroundings. Such information may, for example, relate to physical objects. A physical object may be, for example, a traffic sign, a signaling system, or a road boundary post. The sensor data, in particular, include physical properties or characteristics of the road, such as a road width, a lane width, curve radiuses, and/or ramps. In general, the sensor data include dimensions and/or positions of the physical objects, in particular of the positions relative to one another. This means, for example, that a width, a height and/or a length of the physical object is/are detected. In particular, in the case of stationary physical objects, the particular positions and dimensions are stored in the sensor data. Sensor data may, in particular, also include information regarding instantaneous conditions such as road works in the corresponding position, resulting in changed road properties. Sensor data may, in particular, also include lane data which, for example, include the information regarding a roadway line color.

Sensor data in the sense of the present invention include, in particular, images and/or videos. A corresponding position is in particular assigned to the sensor data. Preferably, a vehicle position is determined at the point in time of the sensory detection of the vehicle surroundings, so that the determined vehicle position may be assigned to the detected vehicle surroundings. In particular, a corresponding position is also assigned to the reference vehicle surroundings, so that the vehicle surroundings may be assigned to the reference vehicle surroundings via the position.

According to one specific embodiment, the surroundings sensor may be a video sensor, a radar sensor, an ultrasonic sensor, or a lidar sensor. The surroundings sensor may preferably be included in a surroundings sensor system for sensory detection of the vehicle surroundings. The surroundings sensor system may also have other surroundings sensors which may be preferably identical or different. In particular, the surroundings sensor system may be a video camera, preferably a 3D video camera, a surroundings camera system for detecting images of the 360° surroundings of the vehicle, a time of flight sensor and/or a photonic mixing device (PMD) sensor. A PMD sensor may, in particular, be used as an image sensor in a TOF camera, TOF being an abbreviation of “time of flight,” and be based on time-of-flight processes. The video camera may be in particular a stereo video camera. It may be preferably provided that the sensor data of a particular sensor are fused and transmitted for checking to the server as fused sensor data. Therefore, a simultaneous calibration of the particular sensors is advantageously possible.

According to one specific embodiment, the vehicle component is a signaling device for a driver in order to provide the information regarding the unsuccessful sensor calibration. This therefore means in particular that the signaling device may signal to the driver that the sensor calibration was unsuccessful. Thus, the driver advantageously learns about the unsuccessful sensor calibration and may preferably manually carry out corresponding measures. The signaling device may preferably be configured for acoustic and/or graphic or visual and/or haptic signaling. This therefore means in particular that it is signaled acoustically and/or visually and/or haptically to the driver that the sensor calibration was unsuccessful.

According to another specific embodiment, the vehicle component is a transmitter for transmitting information regarding the unsuccessful sensor calibration to another server situated externally in relation to the vehicle and/or to the server. This therefore means in particular that the control unit controls the transmitter in such a way that it transmits the information regarding the unsuccessful sensor calibration to the other server and/or to the server. The other server may, for example, be operated by the vehicle manufacturer, so that the vehicle manufacturer learns about a sensor calibration being unsuccessful. The vehicle manufacturer may, for example, use this information for quality control. However, the other server may, for example, also be positioned at a service provider, e.g., a breakdown service company, which thus receives the information regarding the unsuccessful sensor calibration, whereupon the service provider may carry out suitable measures. For example, the service provider may send a repair vehicle to the vehicle. In particular, multiple servers may also be provided which, for example, may be operated by the vehicle manufacturer and by the service provider.

According to another specific embodiment, the vehicle component is a vehicle system which is operable with the aid of the sensor data and which is deactivated in the case of unsuccessful sensor calibration. This therefore means in particular that the control unit deactivates the vehicle system if the sensor calibration is unsuccessful. For this reason, erroneous decisions of the vehicle system may be advantageously avoided, since the vehicle system would otherwise be operated using erroneous sensor data, thus possibly resulting in malfunctions.

The vehicle component may preferably be a driver assistance system. A driver assistance system in the sense of the present invention in particular refers to a system which intervenes semi-autonomously or autonomously into a drive system and/or a control system, e.g., an accelerator and/or a brake and/or a clutch, and/or a steering system and/or signaling devices of the vehicle, a warning also being emitted to the driver alternatively or additionally via a suitable human-machine interface shortly prior to or during critical driving situations.

A driver assistance system may, for example, be a system which receives data from video cameras and ascertains a lane based on the data, and autonomously steers the vehicle back in the case of involuntary departure from the lane. Such a system may also be referred to as a lane keeping support (LKS) system.

The driver assistance system may preferably also be a traffic sign recognition system which may ascertain the specified speed on the basis of visual surroundings sensor systems including a video camera, for example.

The driver assistance system is preferably an object detection system which may detect and classify objects with the aid of visual sensors such as a video camera, for example.

Multiple driver assistance systems may preferably also be provided which may have identical or differing designs.

Thus, due to the driver assistance system being deactivated in the case of an unsuccessful sensor calibration, the driver assistance system cannot carry out actions, i.e., interventions, into a vehicle operation. If the driver assistance system was not deactivated, it could carry out corresponding actions based on non-calibrated sensor data, which could result in critical situations. For example, the system could brake too early or too late, since the information this decision is based on is not correct. In particular, the driver assistance system could output incorrect information to the driver. For example, a traffic sign recognition system could output an incorrectly specified speed to the driver based on the non-calibrated sensor data. It may preferably be provided that the control unit controls the vehicle system, in particular the driver assistance system, in such a way that a corresponding functionality is made available to a limited extent. This therefore means in particular that the vehicle system is no longer able to make available its comprehensive functionality, but only limited functions. In the case of a driver assistance system, this means, for example, that the driver assistance system does not brake or accelerate and/or steer the vehicle autonomously, but only signals to the driver that it would have carried out an autonomous intervention in the concrete driving situation.

According to another specific embodiment, the vehicle component is a navigation system for displaying a position of a repair shop on a digital map. This therefore means in particular that in the case of an unsuccessful sensor calibration, the position of a repair shop, in particular the closest repair shop in relation to an instantaneous vehicle position, is displayed on the digital map of the navigation system. In this way, the driver advantageously receives information as to where the repair shop, in particular the closest repair shop, is located and may, if necessary, drive there immediately to have the sensor calibrated. It may be preferably provided that a route to the repair shop is displayed on the digital map. In particular, it may be provided that the error message is transmitted to the repair shop, in particular transmitted automatically to the repair shop. In this way, the repair shop may advantageously prepare for the upcoming sensor calibration.

In another specific embodiment, it may be provided that an electronic calendar of a driver of the vehicle may be compared, in particular automatically compared, to an electronic repair shop calendar of the repair shop in order to find an overlapping time interval for a sensor calibration or for a sensor repair. This therefore means in particular that an appointment for a sensor calibration or a sensor repair may be agreed on with the repair shop. A time interval which is suitable for both the repair shop and the driver is therefore in particular looked for. An electronic calendar of the driver may in particular be an electronic calendar such as the one implemented in a smart phone, for example.

According to yet another specific embodiment, the unsuccessful sensor calibration is determined by comparing the calibration data to a predetermined calibration limiting value and by ascertaining a predetermined deviation between the calibration data and the calibration limiting value. In this way, the case may be advantageously recognized where the calibration data may be computed mathematically, but these data do not make any sense physically in the real world, since the surroundings sensor would have to be rotated by 180° for the calibration, for example. Although a mathematical theoretical sensor calibration would be possible, based on such a calibration, the surroundings sensor would still not be able to generate sensor data corresponding to reality.

According to yet another specific embodiment, it may be provided that the unsuccessful sensor calibration is determined by detecting a surroundings sensor error signal of the surroundings sensor. This therefore means, in particular, that an error is detected in the surroundings sensor system itself. Such an error may, for example, be a mechanical and/or electrical and/or physical error. In this case, it may be provided that the surroundings sensor system itself carries out a diagnostic procedure and outputs a surroundings sensor error signal in the case of a correspondingly negative result.

In this way, it is advantageously signaled that the surroundings sensor works erroneously. Although here, too, a theoretical calibration is possible, such a calibrated sensor is still not able to provide correct sensor data due to its erroneous functionality.

In another specific embodiment, other sensor data are transmitted to the server for checking the carried-out sensor calibration after a carried-out sensor calibration. This therefore means in particular that other vehicle surroundings are detected sensorially after the carried-out sensor calibration. The corresponding sensor data are then retransmitted to the server which may check the other sensor data based on the reference sensor data. In particular, when the other sensor data are in a predetermined range around the reference sensor data, a successful sensor calibration may be assumed. Starting from a predetermined deviation of the other sensor data in relation to the reference sensor data, an unsuccessful sensor calibration may, in particular, be assumed. In this case, other calibration data are preferably correspondingly generated and transmitted to the surroundings sensor for another sensor calibration.

According to yet another specific embodiment, multiple vehicle components may be provided. This therefore means in particular that the control unit may control multiple vehicle components, in particular simultaneously or consecutively. The vehicle components may preferably be formed identically or differently.

According to another specific embodiment, it may be provided that a communication is carried out between the surroundings sensor and the external server or the other server with the aid of a C2I process, for example. The abbreviation “C2I” stands in this case for “car to infrastructure.” A C2I communication process therefore refers to a communication process between a vehicle and an infrastructure or a physical object which is not a vehicle, e.g., a signaling system or a base station. A communication may preferably also be carried out with the aid of a mobile radio communication process. In particular, such a mobile radio communication process may be the “long-term evolution” (LTE) communication process. Wireless communication processes may also be preferably used in general. For example, the WLAN communication process may be used for a communication between the surroundings sensor and the server or the other server.

In one specific embodiment, it may be provided that the computations to be carried out with regard to the sensor calibration are carried out based on the calibration data in the server, i.e., externally from the vehicle. It may be preferably provided that the computations to be carried out are carried out internally in the vehicle with the aid of a corresponding computing device, e.g., with the aid of a computer. In particular, a combination of internal and external computation may be provided. This therefore means in particular that some of the computations to be carried out are carried out partially externally and partially internally.

The present invention is described in greater detail on the basis of the preferred exemplary embodiments with reference to the drawings.

### BRIEF DESCRIPTION OF THE DRAWINGS

FIG. 1 shows a device for calibrating a surroundings sensor.

FIG. 2 shows a flow chart of a method for calibrating a surroundings sensor.

FIG. 3 shows a system for calibrating a surroundings sensor.

FIG. 4 shows a vehicle.

FIG. 5 shows the vehicle according to FIG. 4 on a road.

### DETAILED DESCRIPTION OF THE INVENTION

The same reference numerals are used below for the same features.

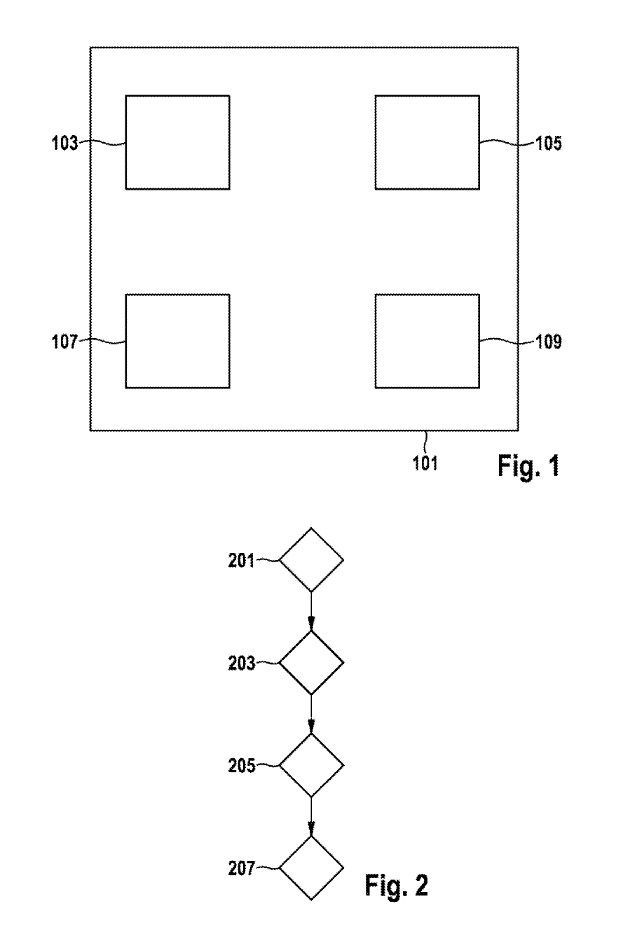

FIG. 1 shows a device 101 for calibrating a surroundings sensor for sensory detection of the surroundings of a vehicle. Device 101 includes a transmitter 103 for transmitting sensor data which are generated with the aid of the surroundings sensor and which correspond to the vehicle surroundings. The sensor data are transmitted to a server situated externally from the vehicle, so that this server may advantageously check the sensor data. Device 101 also includes a receiver 105 for receiving the calibration data for a sensor calibration which are generated with the aid of the server based on the sensor data and reference data corresponding to the reference vehicle surroundings associated with the vehicle surroundings.

Furthermore, device 101 includes a control unit 107 for controlling a vehicle component. Moreover, an error signal generator 109 is provided which generates an error signal in the case of an unsuccessful calibration and transmits this signal to control unit 107. Control unit 107 is furthermore designed to control the vehicle component after receiving the corresponding error signal.

FIG. 2 shows a flow chart of a method for calibrating a surroundings sensor for sensory detection of the surroundings of a vehicle. In a step 201, sensor data which are generated with the aid of the surroundings sensor and correspond to the vehicle surroundings are transmitted to an external server for checking. In a step 203, the server transmits calibration data to the surroundings sensor. The calibration data are generated based on the sensor data and reference sensor data, the reference sensor data corresponding to the reference vehicle surroundings associated with the vehicle surroundings.

According to a step 205, an error signal is transmitted to a control unit in the case of an unsuccessful sensor calibration, whereupon the control unit then controls a vehicle component according to a step 207.

According to one specific embodiment (not shown), the control unit may control a signaling device, so that it signals to the driver that the sensor calibration was unsuccessful. Here, an acoustic and/or graphic or visual and/or haptic signaling to the driver may be provided.

In another specific embodiment (not shown), it may be provided that the control unit controls a transmitter in order to transmit information regarding the unsuccessful sensor calibration to the external server and/or to one or multiple other external servers. For example, such other external server may be located at or operated by a vehicle manufacturer or a service provider, in particular a breakdown service.

In another specific embodiment (not shown), it may be provided that the control unit controls a navigation system, so that the navigation system displays a position of a repair shop on a digital map. The information as to where a repair shop is located to calibrate the sensor is thus advantageously immediately displayed to the driver.

In one specific embodiment (not shown), it may be provided that the control unit controls a vehicle system, in particular a driver assistance system. For example, it may be provided that the control unit deactivates the vehicle system, preferably the driver assistance system. This therefore means in particular that the vehicle system is no longer able to make available a corresponding functionality. It may preferably be provided that the control unit controls the vehicle system, in particular the driver assistance system, in such a way that a corresponding functionality is made available to a limited extent. This therefore means in particular that the vehicle system is no longer able to make available its comprehensive functionality, but only limited functions. In the case of a driver assistance system, this means, for example, that the driver assistance system does not brake or accelerate and/or steer the vehicle autonomously, but only signals to the driver that it would have carried out an autonomous intervention in the concrete driving situation.

The previously mentioned vehicle systems, in particular driver assistance systems, are in particular systems, control units, or components of the vehicle which work with the sensor data of the surroundings sensor. This therefore means in particular that these systems are operated based on the sensor data. This therefore means in particular that the systems use the sensor data in particular as a basis for making a decision during a corresponding decision-making process.

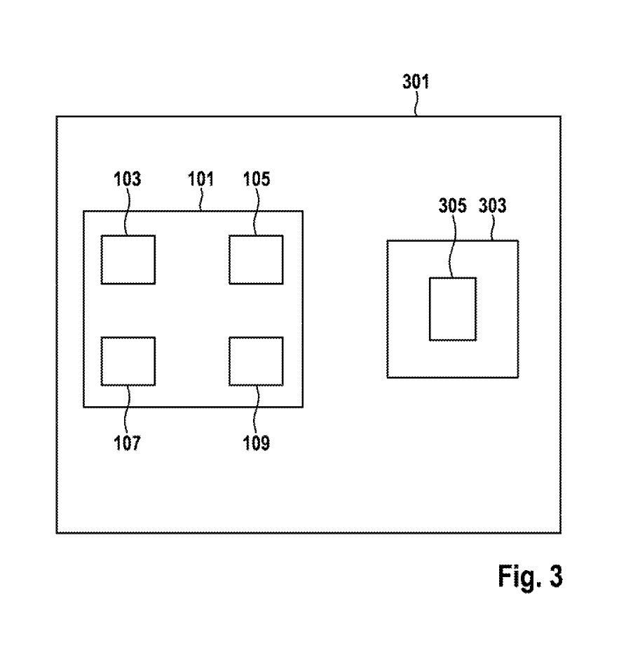

FIG. 3 shows a system 301 for calibrating a surroundings sensor for sensory detection of the surroundings of a vehicle. System 301 includes device 101 according to FIG. 1. Furthermore, system 301 includes a server 303 having a database 305 in which reference sensor data corresponding to the reference vehicle surroundings are stored. To receive the sensor data of device 101 and to transmit the calibration data to device 101, it may in particular be provided that server 303 has a corresponding transmitter and a corresponding receiver which are not shown in FIG. 3 for the sake of clarity.

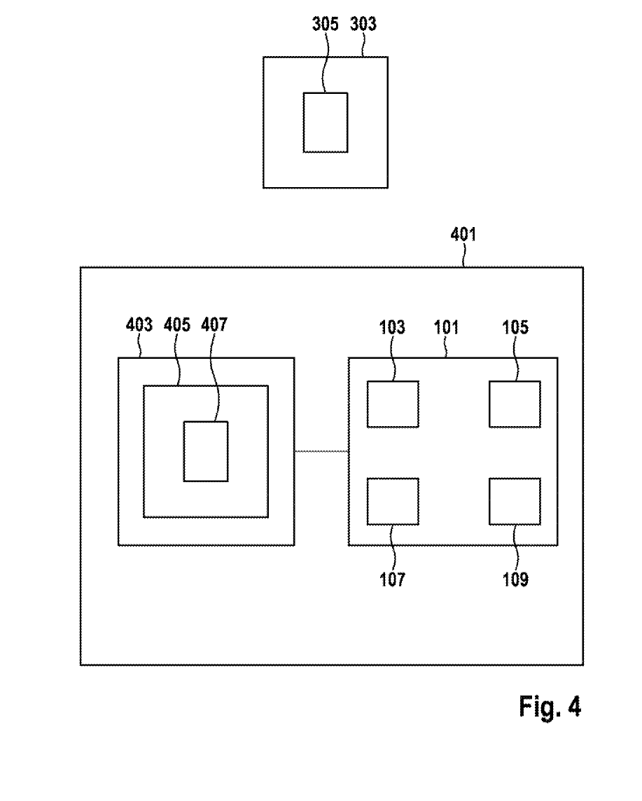

FIG. 4 shows a vehicle 401. Vehicle 401 has a driver assistance system 403. Driver assistance system 403 includes a sensor system 405 having a surroundings sensor 407. In one exemplary embodiment (not shown), it may be provided that surroundings sensor system 405 has multiple surroundings sensors 407. Multiple surroundings sensors 407 may in particular be formed identically or differently. In another specific embodiment (not shown), it may be provided that vehicle 401 has multiple driver assistance systems which may be formed identically or differently, in particular.

Furthermore, vehicle 401 includes device 101 according to FIG. 1.

Moreover, server 303 is also shown having database 305 according to FIG. 3.

Surroundings sensor 407 of surroundings sensor system 405 sensorially detects the surroundings of vehicle 401. The corresponding sensor data are transmitted to server 303 with the aid of transmitter 103. Server 303 checks the sensor data by comparing them with the reference sensor data which are stored in database 305. Based on a result of this comparison, calibration data are generated which are transmitted by server 303 to receiver 105 of device 101. Subsequently, a sensor calibration is carried out, it being provided in the case of an unsuccessful sensor calibration in particular that error signal generator 109 generates a corresponding error signal and transmits it to control unit 107. Control unit 107 will subsequently deactivate driver assistance system 403, in particular, or delimit its functionality. This therefore means in particular that driver assistance system 403 may no longer make available its full functionality.

In one specific embodiment (not shown), control unit 107 may also control, in particular deactivate or delimit the functionality of, other vehicle components, in particular other driver assistance systems.

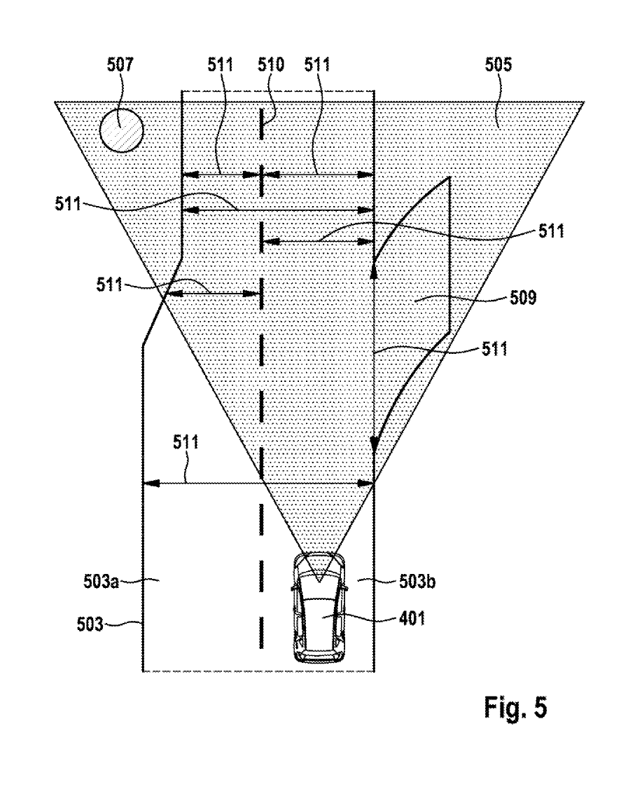

FIG. 5 shows vehicle 401 according to FIG. 4 on a road 503. Device 101 and driver assistance system 403 are not shown in FIG. 5 for the sake of clarity.

With the aid of surroundings sensor 407, vehicle 401 detects the vehicle surroundings which are indicated here with the aid of a triangle having reference numeral 505. Here, surroundings sensor 407 detects, for example, a stationary physical object 507 and a ramp 509. In particular, the dimensions of the detected objects are determined with the aid of surroundings sensor 407. Thus, surroundings sensor 407 detects, for example, a width, a height, and a depth of stationary object 507. In particular, surroundings sensor 407 also detects a width of road 503, of ramp 509, and of corresponding lanes 503a and 503b of road 503 which are separated from one another with the aid of a dashed lane-limiting line 510.

A particular width of lanes 503a, 503b, road 503, and ramp 509 is schematically indicated in FIG. 5 with the aid of a corresponding double arrow having reference numeral 511.

Furthermore, surroundings sensor 407 includes in particular also a relative position of the individually detected objects to one another, i.e., in particular the corresponding distances to one another.

The above-mentioned information, i.e., the dimensions, the positions, and in particular the relative positions are included in the sensor data. These sensor data are then transmitted to server 303 which is not shown in FIG. 5 for the sake of clarity. This server compares the dimensions and the positions, in particular the relative positions, to the reference sensor data which include the reference dimensions and the reference positions, in particular the relative reference positions, of the detected objects. Corresponding calibration parameters which are sent back to vehicle 401 as calibration data are then generated from a corresponding difference.

Based on these calibration data, a calibration of surroundings sensor 407 may be carried out, it being provided in particular in the case of an unsuccessful calibration that driver assistance system 403 is deactivated.

In another specific embodiment (not shown), it may be provided that quality data or quality factors are assigned or integrated into the database for the objects and the corresponding reference sensor data. This therefore means in particular that a statement may be made as to how good the reference sensor data are or what quality the reference sensor data have. These quality factors are then preferably used for computing the calibration data.

To sum up, the present invention in particular includes the idea of providing a calibration method for a surroundings sensor, the surroundings sensor generating sensor data which are compared to reference sensor data of a database. If in this case a difference is ascertained, for example, corresponding calibration parameters are subsequently computed based on this difference. A sensor calibration is then carried out with the aid of these calibration parameters. If, however, it is not possible or not longer possible to remedy the deviation, i.e., a sensor calibration, with the aid of the calibration data because the deviations are excessive, for example, or there is a mechanical and/or electrical and/or physical error in the system or in the surroundings sensor system, an error signal is generated and transmitted to a control unit which subsequently controls a vehicle component.

A surroundings sensor is thus advantageously regularly checked for sufficient calibration. The surroundings sensor is recalibrated if at all possible. If recalibration is not possible, an action is carried out; in particular an error signal is transmitted to a control unit, whereupon the control unit then controls a vehicle component.

1-15. (canceled)

16. A method for calibrating a surroundings sensor for sensory detection of surroundings of a vehicle, comprising:
transmitting sensor data, which are generated with the aid of the surroundings sensor and which correspond to detected vehicle surroundings, to a first server situated externally from the vehicle;
generating, by the server, calibration data based on a comparison of the sensor data with reference sensor data which correspond to reference vehicle surroundings associated with the detected vehicle surroundings;
transmitting, by the server, the calibration data to the surroundings sensor;
initiating a calibration of the surroundings sensor using the calibration data; and
transmitting, in the case of an unsuccessful calibration of the surroundings sensor, an error signal to a control unit which subsequently controls at least one vehicle component.

17. The method as recited in claim 16, wherein the vehicle component is a signaling device which provides information regarding the unsuccessful sensor calibration to a driver.

18. The method as recited in claim 16, wherein the vehicle component is a transmitter for transmitting information regarding the unsuccessful sensor calibration to at least one of the first server and a second server situated externally from the vehicle, the second server being a server of a breakdown service.

19. The method as recited in claim 16, wherein the vehicle component is a vehicle system which is configured to be (i) operable with the aid of the sensor data and (ii) deactivated in the case of an unsuccessful sensor calibration.

20. The method as recited in claim 19, wherein the vehicle system is a driver assistance system.

21. The method as recited in claim 16, wherein the vehicle component is a navigation system for displaying at least one of (i) a position of a repair shop and (ii) a route to the repair shop on a digital map.

22. The method as recited in claim 21, wherein the error message is transmitted to the repair shop.

23. The method as recited in claim 21, wherein an electronic calendar of a driver of the vehicle is automatically compared to an electronic repair shop calendar of the repair shop in order to find an overlapping open time interval for a sensor calibration.

24. The method as recited in claim 16, wherein the unsuccessful sensor calibration is determined by comparing the calibration data to a predetermined calibration limiting value and by ascertaining a predetermined deviation between the calibration data and the calibration limiting value.

25. The method as recited in claim 24, wherein the unsuccessful sensor calibration is determined by detecting a surroundings sensor error signal of the surroundings sensor.

26. The method as recited in claim 16, further comprising:
transmitting, after a carried-out sensor calibration, other sensor data to the server for checking the carried-out sensor calibration.

27. The method as recited in claim 21, wherein the control unit controls multiple vehicle components.

28. A system for calibrating a surroundings sensor for sensory detection of surroundings of a vehicle, comprising:
a transmitter for transmitting sensor data, which are generated with the aid of the surroundings sensor and which correspond to detected vehicle surroundings, to a first server situated externally from the vehicle, wherein the server generates calibration data based on a comparison of the sensor data with reference sensor data which correspond to reference vehicle surroundings associated with the detected vehicle surroundings;
a receiver for receiving the calibration data from the server;
a means for initiating a calibration of the surroundings sensor using the calibration data;
a control unit for controlling a vehicle component; and
an error signal generator for generating and transmitting an error signal to the control unit in the event of an unsuccessful calibration of the surroundings sensor, which control unit subsequently controls the vehicle component.

29. The system for calibrating a surroundings sensor as recited in claim 28, wherein the server has a database in which the reference sensor data corresponding to the reference vehicle surroundings are stored.

30. A non-transitory computer-readable data storage medium storing a computer program having program codes which, when executed on a computer, performs a method for calibrating a surroundings sensor for sensory detection of surroundings of a vehicle, the method comprising:
transmitting sensor data, which are generated with the aid of the surroundings sensor and which correspond to detected vehicle surroundings, to a first server situated externally from the vehicle;
generating, by the server, calibration data based on a comparison of the sensor data with reference sensor data which correspond to reference vehicle surroundings associated with the detected vehicle surroundings;
transmitting, by the server, the calibration data to the surroundings sensor;
initiating a calibration of the surroundings sensor using the calibration data; and
transmitting, in the case of an unsuccessful calibration of the surroundings sensor, an error signal to a control unit which subsequently controls at least one vehicle component.
